(19) United States
(12) Patent Application Publication
(10) Pub. No.: US 2008/0004388 A1
(43) Pub. Date: Jan. 3, 2008

(54) Thermoplastic Plyurethanes Containing Plasticizer

(75) Inventors: Hauke Malz, Diepholz (DE); Thomas Flug, Wagenfeld (DE); Christa Hackl, Bad Essen (AT); Horst Welzel, Hannover (DE); Martin Vallo, Bramsche (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/572,329

(22) PCT Filed: Jul. 20, 2005
(86) PCT No.: PCT/EP05/07889

§ 371 Date: Jan. 19, 2007

(30) Foreign Application Priority Data
Jul. 26, 2004 (DE) 102004036202.5

(51) Int. Cl. C08K 5/06; C08J 3/18

(52) U.S. Cl. 524/378; 524/589; 525/384

(57) ABSTRACT

Thermoplastics comprising plasticizer (i), wherein the plasticizer (i) is based on a polyether having at least one hydroxy group, and the at least one hydroxy group in the plasticizer has been alkylated or has been esterified with a monocarboxylic acid.

The present invention relates to thermoplastics, preferably thermoplastic polyurethanes, comprising plasticizer (i), where the plasticizer (i) is based on a polyether having at least one, preferably from 1 to 6, particularly preferably from 1 to 4, in particular 1 or 2, hydroxy groups, and the at least one, preferably from 1 to 6, particularly preferably from 1 to 4, in particular 1 or 2, hydroxy group(s) in the plasticizer has been alkylated, preferably methylated, or has been esterified with a monocarboxylic acid, preferably acetic acid. The invention further relates to a process for the production of thermoplastic polyurethanes, preferably via reaction of (a) isocyanates with (b) compounds reactive toward isocyanates and having a molar mass of from 500 to 10 000 g/mol, and, if appropriate, with (c) chain extenders having a molar mass of from 50 to 499 g/mol, if appropriate in the presence of (d) catalysts, and/or of (e) conventional auxiliaries, where the inventive plasticizers are added to the thermoplastic polyurethane during and/or after the production process, preferably during and/or after the reaction of the isocyanates (a) with the compounds reactive toward isocyanates and having a molar mass of from 500 to 10 000 g/mol, and, if appropriate, with (c) chain extenders having a molar mass of from 50 to 499 g/mol.

Thermoplastic polyurethanes, hereinafter also termed TPUs, are versatile plastics. By way of example, TPUs are found in the automotive industry, e.g. in instrument panel skins, in films, in cable sheathing, in the leisure industry, as heel lifts, as functional and design elements in sports shoes, and as soft component in hard/soft combinations.

The hardness of TPUs is usually from 80 Shore A to 74 Shore D. However, many of the abovementioned applications require hardness below 80 Shore A. It is therefore prior art to add plasticizers to TPUs, these being materials which can lower Shore hardness. Examples of familiar plasticizers are benzoates, phthalates, and phosphoric esters.

When selecting the plasticizer, it is preferable to ensure that the product is compatible with the TPU. In this context, compatible means that the plasticizer must be capable of admixture with the TPU during the processes conventionally used for TPU production, and that there is then maximum continuous retention of the plasticizer within the product, rather than its loss via exudation or evaporation. In addition, there should be no deterioration of the mechanical properties of the TPU, e.g. abrasion and elastomeric properties. Many plasticized TPUs find their way into applications which also involve exposure to sunlight, e.g. design elements in the shoe industry. Here, it is disadvantageous for the plasticizer to contribute to yellowing of the product via UV degradation.

EP 1 106 634 describes a polyurethane plasticizer based on a polyether prepolymer having an NCO content<13%, which has been reacted with a monoalcohol. The problem with this type of plasticizer production process is the residual monomer content of the prepolymer. These residual monomers react with the monoalcohol to give a diurethane which is incompatible with TPU and can cause a white bloom. In addition a urethane bond has reversible thermal cleavage properties, and a plasticizer comprising a urethane bond therefore, via thermal degradation, causes molar mass degradation of the polyurethane to be plasticized, and therefore a reduction in mechanical performance.

U.S. Pat. No. 3,956,221 describes the production of compact, rigid crosslinked polyurethanes in the presence of polyethers based on ethylene oxide and propylene oxide in a 50:50 ratio, the polyether having an end cap which is an alkyl group having from 1 to 6 carbon atoms. U.S. Pat. No. 2,782,240 discloses the alkylation of polyethers.

JP 2001-323043 describes a method for the production of plasticizers for polyurethanes, where alkoxy polyalkylene glycols and isocyanate are compounded. The alkoxy polyalkylene ether has the general formula RO(R₁O)ₘ(R₂O)ₙH, where n=from 1 to 50 and m=from 0 to 20. R₁ here is an ethyl group and R₂ is a radical other than an ethyl group, e.g. a propyl radical or butyl radical.

JP 2001-342340 describes a polyurethane powder for slush applications and its method of production, comprising a pulverulent polyurethane and a plasticizer composed of an alkoxy poly(oxyalkylene) glycol and of a molar mass of from 100 to 1000 and of an organic diisocyanate.

It was therefore an object of the present invention to develop a plasticized thermoplastic, in particular a plasticized thermoplastic polyurethane, where the plasticizer used has good incorporation properties, does not cause bloom, and is not lost via evaporation, and at the same time improves the properties of the plastic, such as processability, heat resistance, and UV resistance.

The object was achieved via the thermoplastics described at the outset, comprising the plasticizers (i).

The molar mass of the compound (i) is preferably from 400 to 6000 g/mol, particularly preferably from 800 to 2000 g/mol, in particular from 800 to 1200 g/mol. The compound (i) is also termed “plasticizer” in this specification, on the basis of its property.

A particular advantage of using the inventive molecules (i) as plasticizer arises when the compounds (i) are liquid at room temperature i.e. at 25° C., at a pressure of 1 bar. This can be achieved if the compounds (i) are based on ethylene oxide and on propylene oxide, and if the respective alkylene oxides have not been arranged in blocks within the compound (i).

Surprisingly, the compatibility of the inventive compound (i) with the TPU is particularly high when a high proportion of ethylene oxide is present in the compound (i). Preference is therefore given to plasticizers whose proportion by weight of ethylene oxide units in the polyetherol is from 50 to 95% by weight, preferably from 60 to 90% by weight, particularly preferably from 66 to 80% by weight. The % by weight data here are based on the proportion by weight of the structural unit —[O—CH₂—CH₂]—, based on the total weight of the compound (i). The compound (i) preferably has the following structural unit: 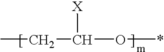
where X and m are defined as follows:
X: H or CH₃
m: a whole number from the range from 1 to 90, preferably from 8 to 50, in particular from 20 to 30, where preferably the proportion of the repeat units where X═H is defined via the preferred ratio of EO to PO.

The proportion by weight of ethylene oxide units to propylene oxide units in the polyether (i) is particularly important for solubility in the thermoplastic polyurethane, because the ratio affects the polarity of the plasticizer and therefore its solubility. Particular preference is given to plasticizers (i) prepared with use of ethylene oxide and propylene oxide, where the proportion by weight of ethylene oxide units in the plasticizer (i) is from 66 to 80% by weight, the % by weight data relating to the proportion by weight of the structural unit —[O—CH₂—CH₂]—, based on the total weight of the compound (i), and particularly preferably those in which the ethylene oxide units and propylene oxide units have not been arranged in blocks. The statement that the units have not been arranged in blocks means that the units have been arranged randomly, e.g. by carrying out the alkoxylation process with a mixture of ethylene oxide and propylene oxide.

Polyetherols composed of ethylene oxide (also termed NO in this specification) and propylene oxide (also termed PO in this specification) are typical raw materials for polyurethane synthesis, and there are many commercially available products differing in PO/EO ratio, functionality and molar mass. Their preparation is well known. For the production of TPU, the general method uses only PO/EO ethers having a functionality of 2. Typical OH numbers of these PO/EO ethers are from 200 to 30 mg KOH/g.

The preferred method of preparation of polyetherols forms an adduct of EO and/or PO onto starter substances which have from 1 to 6 hydroxy groups, preferably from 1 to 4 hydroxy groups, particularly preferably from 1 to 2 hydroxy groups. Preference is given to aliphatic starter molecules having from 1 to 8 carbon atoms, preferably from 1 to 6 carbon atoms, in particular from 1 to 3 carbon atoms, e.g. methanol, ethanol, propanol, allyl alcohol, ethylene glycol, propylene glycol. PO/EO ethers may be prepared by well-known processes. By way of example, the starter substances may be treated with the alkylene oxide at a temperature of, by way of example, from 70 to 160° C., preferably from 80 to 150 G, in a conventional reactor (stirred-tank reactors, tubular reactors, etc.), which preferably may have been equipped with conventional equipment for cooling of the reaction mixture. The alkylene oxides may preferably be added in such a way that the reaction temperature is within the range from 70 to 160° C., preferably from 80 to 150° C. The reaction times usually depend on the temperature profile of the reaction mixture and therefore depend on the batch size, the reactor type, and the cooling equipment, inter alia. The reaction may be carried out at pressures of from 0.1 to 1 MPa, preferably from 0.1 to 0.7 MPa. The crosslinking polyols prepared according to the invention may be purified in a known manner, e.g. by approximately neutralizing the reaction mixture with mineral acids, such as hydrochloric acid, sulfuric acid, and/or preferably phosphoric acid, or with organic acids or with carbon dioxide, to give a pH which is usually from 6 to 8, using conventional vacuum distillation to remove the water from the polyether polyalcohol, and removing the salts by filtration. High residual alkali metal content impairs the production of TPU, because the residual alkali metal catalyzes side-reactions, such as isocyanurate formation, during synthesis of the TPU. These side-reactions reduce the quality of the TPU. For the preparation of (i), it is preferable to use PO/HO ethers whose residual alkali metal content is <40 ppm, particularly preferably <15 ppm, with particular preference <5 ppm.

The starter substances to be alkoxylated may preferably receive addition of a conventional amount of a strong base, for example from 0.02 to 2% by weight, preferably from 0.04 to 0.08% by weight, based on the mixture comprising the starter substances, so that the starter substances are at least to some extent in deprotonated form. Preferred strong bases which may be used are alkali metal hydroxides, particularly preferably NaOH and/or KOH in dissolved or preferably solid form, Examples of starter molecules are methanol, ethanol, propanol, allyl alcohol, ethylene glycol, propylene glycol, butanediol, etc.

The ratio of starter molecule to PO+EO controls the molar mass of the polyetherol. Preferred molar masses of i) are from 400 to 6000 g/mol, preferably from 800 to 2000 g/mol.

The proportion of PO and EO may be varied within a wide range, but preference is given to the use of polyethers which comprise both PO and EO units. Particular preference is given to the polyethers described at the outset with the particularly preferred proportion of EO. Preference is given here to use of a random distribution of the PO and EO units.

The inventive plasticizers (i) may be prepared from the polyethers preferably based on EO and PO by reacting the polyether which has at least one, preferably one or two, hydroxy groups with a compound (ii) which bears a functional group which can react with the hydroxy group(s) of the polyether. Examples of functional groups are carboxy groups or derivatives of the carboxy group, e.g. esters, anhydrides, or chlorides, or methylating agents, such as dimethyl sulfate or methyl bromide. The reaction product from methylation as an example of alkylation of the hydroxy group would be the methoxy radical.

The compound (ii) is preferably an aliphatic compound having from 1 to 8 carbon atoms, preferably from 1 to 4 carbon atoms, in particular from 1 to 2 carbon atoms. Examples of preferred compounds (ii) are acetic acid, acetic anhydride, acetyl chloride, methyl bromide, or dimethyl sulfate. Particular preference is given to acetic acid and to derivatives of acetic acid, e.g. acetic anhydride or ethyl acetate. Acetic acid and acetic anhydride are in particular preferred.

A preferred method of carrying out the process for the esterification of a polyether having at least one, preferably one, hydroxy group with a carboxylic acid, preferably monocarboxylic acid, particularly preferably acetic acid, i.e. the reaction of the polyethers with compound (ii) to give the plasticizer (i) consists in heating, to 110-160° C., preferably 120-140° C., the polyether, which preferably has an EO/PO ratio of 3:1, and/or preferably has an OH number of 55 mg KOH/g, with a stoichiometric amount of acetic anhydride and with an amount of acetic acid which is from 10 to 100% by weight of the stoichiometric amount of acetic acid, in a reactor, preferably with exclusion of oxygen, e.g. under nitrogen, and then preferably adding transesterification catalyst. The term stoichiometric amount means the molar amount corresponding to the number of moles of hydroxy groups of the polyether. Transesterification catalysts which may be used are well-known transesterification catalysts, e.g. tin catalysts, e.g. dibutyltin dilaurate or stannous dioctoate, titanium compounds, such as titanium tetrabutoxide, or a sulfonic acid, such as toluenesulfonic acid. Stannous dioctoate is preferred. The usual amounts of stannous dioctoate added are from 1 to 1000 ppm, preferably from 5 to 200 ppm, in particular from 20 to 100 ppm. Once the reaction has proceeded, the excess acetic acid can be removed from the plasticizer (i) distillation.

Particular preference is given to plasticizers (i) in which the number-average molar mass is smaller than the weight-average molar mass. This reduces the tendency of the product to crystallize.

The viscosity of the plasticizer (i), measured to ISO 3219 at 60° C. is preferably from 1 to 100 000 mPas, with preference from 10 to 10 000 mPas, in particular from 100 to 1000 mPas.

The reaction of the terminal hydroxy group(s) generally gives the plasticizers (i) a low hydroxy number. The hydroxy number of the plasticizers (i) is preferably smaller than 10 mg KOH/g, particularly preferably smaller than 5 mg KOH/g, in particular smaller than 2 mg KOH/g. A small OH number guarantees that the plasticizer has no effect on the stoichiometry of the urethane reaction.

The plasticizers (i) preferably have a low acid number, smaller than 2, particularly preferably smaller than 0.5, in particular smaller than 0.05. A low acid number guarantees that there is no adverse effect due to the plasticizer on the hydrolysis process, in particular the hydrolysis of the ester urethanes.

The Hazen number indicating the intrinsic color of the inventive plasticizers is preferably smaller than 100, particularly preferably smaller than 50, in particular smaller than 30. This guarantees that the TPU has little intrinsic color.

The alkali metal content of the plasticizers (i) is preferably smaller than 40 ppm, particularly preferably smaller than 15 ppm, in particular smaller than 5 ppm.

The water content of the inventive plasticizers is usually smaller than 0.2% by weight, preferably smaller than 0.05% by weight, particularly preferably smaller than 0.02% by weight. Excessive water content causes foaming of the products on addition of isocyanate, undesired formation of urea, and a lowering of the level of mechanical properties.

In a preferred method of production of the inventive thermoplastic polyurethanes comprising the plasticizer (i), (a) isocyanates can be reacted with (b) compounds reactive toward isocyanates and having a molar mass of from 500 to 10 000 g/mol, and, if appropriate, with (c) chain extenders having a molar mass of from 50 to 499 g/mol, if appropriate in the presence of (d) catalysts, and/or of (e) conventional auxiliaries, where the inventive plasticizers are added to the thermoplastic polyurethane during and/or after the production process, preferably during and/or after the reaction of the isocyanates (a) with the compounds reactive toward isocyanates and having a molar mass of from 500 to 10 000 g/mol and, if appropriate, with (c) chain extenders having a molar mass of from 50 to 499 g/mol. The plasticizer may therefore be metered into at least one of the starting materials before the process to produce the TPUs has ended, or else may be mixed, e.g. in a conventional extruder, with previously prepared TPU.

The Shore hardness of the thermoplastic polyurethane comprising the compound (i) is preferably from 40 to 80 Shore A.

The amount of the inventive compounds (i) present in the thermoplastic, preferably in the thermoplastic polyurethane is preferably from 1 to 60% by weight, particularly preferably from 5 to 40% by weight, in particular from 10 to 25% by weight, based in each case on the total weight of the thermoplastic comprising the plasticizer (i).

Processes for the production of TPU are well known. By way of example, the thermoplastic polyurethanes may be produced via reaction of (a) isocyanates with (b) compounds reactive toward isocyanates and having a molar mass of from 500 to 10 000, and, if appropriate, with (c) chain extenders having a molar mass of from 50 to 499, if appropriate in the presence of (d) catalysts and/or of (e) conventional auxiliaries and/or additives. The inventive plasticizers (i) may be introduced either prior to or during the production of the TPUs, into the compounds (b) reactive toward isocyanates, or else into the finished TPU, for example into the molten or softened TPU. The thermoplastic polyurethane can be processed thermoplastically without loss of the action of the inventive plasticizers. The starting components and processes for the production of the preferred TPUs will be described by way of example below. The components usually used during the production of the TPUs: (a), (b), (c), and also, if appropriate, (d) and/or (e) will be described below by way of example,
a) Organic isocyanates (a) which may be used are well-known aliphatic, cycloaliphatic, araliphatic, and/or aromatic isocyanates, for example tri-, tetra-, penta-, hexa-, hepta-, and/or octamethylene diisocyanate, 2-methylpentamethylene 1,5-diisocyanate, 2-ethylbutylene 1,4-diasocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI) cyclohexane 1,4-diisocyanate, 1-methylcyclohexane 2,4- and/or 2,6-diisocyanate and/or dicyclohexylmethane 4,4′-, 2,4′-, and 2,2′-diisocyanate, diphenylmethane 2,2′-, 2,4′-, and/or 4,4′-diisocyanate (MDI), 1,5-naphthylene diisocyanate (NDI), tolylene 2,4- and/or 2,6-diisocyanate (TDI), diphenylmethane diisocyanate, 3,3′-dimethyldiphenyl diisocyanate, 1,2-diphenylethane diisocyanate and/or phenylene diisocyanate. Particular preference is given to use of 4,4′-MDI.
b) Compounds (b) which are reactive toward isocyanates and which may be used are the well-known compounds reactive toward isocyanates, for example polyesterols, polyetherols, and/or polycarbonatediols, these usually also being brought together under the term “polyols”, with molar masses of from 500 to 8000, preferably from 600 to 5000, in particular from 800 to 3000, and preferably with an average functionality of from 1.8 to 2.3, preferably from 1.9 to 2.2, in particular 2. The compounds (b) preferably have only primary hydroxy groups.
c) Chain extenders (c) which may be used are well-known aliphatic, araliphatic, aromatic and/or cycloaliphatic compounds with a molar mass of from 50 to 499, preferably bifunctional compounds, for example diamines and/or alkanediols having from 2 to 10 carbon atoms in the alkylene radical, in particular 1,4-butanediol, 1,6-hexanediol, and/or di-, tri-, tetra-, penta-, hexa-, hepta-, octa-, nona-, and/or decaalkylene glycols having from 3 to 8 carbon atoms, and preferably corresponding oligo- and/or polypropylene glycols. Mixtures of the chain extenders may also be used here. The compounds (c) preferably have only primary hydroxy groups.
d) Suitable catalysts which in particular accelerate the reaction between the NCO groups of the diisocyanates (a) and the hydroxy groups of the structural components (b) and (c) are the known and conventional tertiary amines of the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane, and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like. The amounts usually used of the catalysts are from 0.0001 to 0.1 part by weight per 100 parts by weight of polyhydroxy compound (b). It is preferable to use tin catalysts, in particular stannous dioctoate.
e) Besides catalysts (d), other materials which may be added to the structural components (a) to (c), alongside the inventive plasticizers (i), are conventional auxiliaries (a) By way of example, mention may be made of su face-active substances, fillers, flame retardants, nucleating agents, antioxidants, lubricants, and mold-release agents, dyes, and pigments, and, if appropriate, stabilizers in addition to the stabilizers of the invention, e.g. with respect to hydrolysis, light, heat, or discoloration, inorganic and/or organic fillers, reinforcing agents, and plasticizers. Hydrolysis stabilizers used are preferably oligomeric and/or polymeric aliphatic or aromatic carbodiimides. Stabilizers may preferably be added to the inventive TPUs to stabilize them with respect to aging. For the purposes of the present invention, stabilizers are additives which protect a plastic or a plastic mixture from adverse effects of the environment. Examples are primary and secondary antioxidants, hindered amine light stabilizers, UV absorbers, hydrolysis stabilizers, quenchers, and flame retardants. Examples of commercially available stabilizers are given in Plastics Additive Handbook, 5th Edition, H. Zweifel, ed., Hanser Publishers, Munich, 2001 ([1]), pp. 98-136.

If the inventive TPU is exposed to thermo-oxidative degradation during its use, antioxidants may be added. It is preferable to use phenolic antioxidants, Examples of phenolic antioxidants are given in Plastics Additive Handbook, 5th edition, H. Zweifel, ed., Hanser Publishers, Munich, 2001, pp. 98-107 and pp. 116-121.

Preference is given to phenolic antioxidants whose molar mass is greater than 700 g/mol. An example of a phenolic antioxidant whose use is preferred is pentaerythrityl tetrakis(3-(3,5-b is 1,1-dimethylethyl)-4-hydroxyphenyl)propionate) (Irganox® 1010). The concentrations used of the phenolic antioxidants are generally from 0.1 to 5/by weight, preferably from 0.1-2% by weight in particular from 0.5-1.5% by weight.

Although the preferred constitution of the inventive TPUs may make them markedly more resistant to ultraviolet radiation than, for example, TPU plasticized with phthalates or with benzoates, a stabilizer system comprising only phenolic stabilizers is often not sufficient, Inventive TPUs exposed to UV light are therefore preferably also stabilized with a UV absorber. UV absorbers are well known and are molecules which absorb high-energy UV light and dissipate the energy. Familiar UV absorbers used in industry come, by way of example, from the group of the cinnamic esters, the diphenylcyanoacrylates, the formamidines, the benzylidenemialonates, the diarylbutadienes, the triazines, and the benzotriazoles. Examples of commercially available UV absorbers are found in Plastics Additives Handbook, 5th edition, H. Zweifel, ed., Hanser Publishers, Munich, 2001, pp. 116-122.

In one preferred embodiment, the UV absorbers have a number-average molar mass greater than 300 g/mol, in particular greater than 390 g/mol. The molar mass of the UV absorbers whose use is preferred should moreover not be greater than 5000 g/mol, particularly preferably not greater than 2000 g/mol.

Particularly suitable UV absorbers are the benzotriazoles group. Examples of particularly suitable benzotriazoles are Tinuvin® 213, Tinuvin® 328, Tinuvin® 571, and Tinuvin® 384, and Eversorb® 82. The amounts usually added of the UV absorbers are from 0.01 to 5% by weight, based on the total weight of TPU, preferably from 0.1 to 2.0% by weight, in particular from 0.2 to 0.50 by weight.

The UV stabilizer system described above, based on an antioxidant and a UV absorber, is often still not sufficient to ensure that the inventive TPU has good resistance to the damaging effect of UV radiation. In this case, a hindered amine light stabilizer (HALS) may be added to the inventive TPU, in addition to the antioxidant and to the UV absorber. The activity of HALS compounds is based on their ability to form nitro 1 radicals which intervene in the mechanism of oxidation of polymers. HALS are highly efficient UV stabilizers for most polymers.

HALS compounds are well known and are available commercially. Examples of commercially available HALS stabilizers are found in Plastics Additive Handbook, 5th edition, H. Zweifel, Hanser Publishers, Munich, 2001, pp. 123-136.

Preferred hindered amine light stabilizers are those whose number-average molar mass is greater than 500 g/mol. The molar mass of the preferred HALS compounds should moreover not be greater than 10 000 g/mol, particularly preferably not greater than 5000 g/mol.

Particularly preferred hindered amine light stabilizers are b is 1,2,2,6,6-pentamethylpiperidyl)sebacate (Tinuvin® 765, Ciba Spezialitätenchemie AG) and the condensate of 1-hydroxyethyl-2,2,6,6-tetramethyl-4-hydroxypiperidine and succinic acid (Tinuvin® 622). Particular preference is given to the condensate of 1-hydroxyethyl-2,2,6,6-tetramethyl-4-hydroxypiperidine and succinic acid (Tinuvin® 622) if the titanium content of the product is <150 ppm, preferably <50 ppm, in particular <10 ppm.

HALS compounds are preferably used at a concentration of from 0.01 to 5% by weight, particularly preferably from 0.1 to 1% by weight, in particular from 0.15 to 0.3% by weight.

One particularly preferred UV stabilizer system comprises a mixture composed of a phenolic stabilizer, of a benzotriazole, and of a HALS compound, in the preferred amounts described above.

Further information concerning the abovementioned auxiliaries and additives can be found in the technical literature, e.g. from Plastics Additive Handbook, 5th edition, H. Zweifel, ed., Hanser Publishers, Munich, 2001.

All of the molar masses mentioned in this specification have the unit [g/mol]. To adjust hardness of the TPUs, the molar ratios of the structural components (b) and (c) may be varied relatively widely. Molar ratios which have proven successful between component (b) and the entire amount of chain extenders (c) to be used are from 10:1 to 1:10, in particular from 1:1 to 1:4, the hardness of the TPUs rising as content of (c) increases. The reaction may take place at conventional indices, preferably at an index of from 60 to 120, particularly preferably at an index of from 30 to 110. The index is defined via the ratio of the total number of isocyanate groups used during the reaction in component (a) to the groups reactive toward isocyanates, i.e. the active hydrogen atoms, in components (b) and (c). If the index is 100, there is one active hydrogen atom, i.e. one function reactive toward isocyanates, in compounds (b) and (c) for each isocyanate group in component (a). If the index is above 100, there are more isocyanate groups present than OH groups. The TPUs may be prepared by the known processes continuously, for example using reactive extruders or the belt process by the one-shot method or prepolymer method, or batchwise by the known prepolymer process. In these processes, components (a), (b), and, if appropriate, (c), (d), and/or (a) to be reacted are mixed with one another in succession or simultaneously, whereupon the reaction begins immediately. In the extruder process, structural components (a), (b), and also, if appropriate, (c), (d), and/or (e) are introduced, individually or as a mixture, into the extruder, and reacted, e.g. at temperatures of from 100 to 280° C., preferably from 140 to 250° C., and the resultant TPU is extruded, cooled, and pelletized. Conventional processes, e.g. injection molding or extrusion, are used to process the TPUs of the invention, comprising the plasticizers of the invention, these usually being in the form of pellets or powder, to give the desired films, moldings, rollers, fibers, coverings within automobiles, tubing, cable plugs, folding bellows, drag cables, cable sheathing, gaskets, drive belts, or attenuating elements. The thermoplastic polyurethanes which can be produced by the inventive processes, preferably the films, moldings, rollers, fibers, coverings within automobiles, wiper blades, tubing, cable plugs, folding bellows, drag cables, cable sheathing, gaskets, drive belts, or attenuating elements, have the advantages described at the outset.

### EXAMPLES

### Example 1

750 g (0.34 mol) of a dihydric polyetherol based on ethylene oxide and propylene oxide, prepared by the block procedure, molar mass 2100 g/mol (BASE Aktiengesellschaft) were weighed into a 1 four-necked flask with 40.86 g of acetic acid (0.68 mol, 100% of the stoichiometric amount required) and 69.47 g of acetic anhydride, and flushed with nitrogen to remove dissolved oxygen. The mixture was then heated under nitrogen to 160° C. with stirring. Once the temperature of 160° C. had been reached, the catalyst (50 ppm of stannous dioctoate) was added to the solution. After 8 h, the excess acetic acid was removed by distillation in vacuo. Analysis of the final product gave an OH number of 0.5 and an acid number of 0.02. The alkali metal content is <5 ppm.

### Example 2

### Synthesis of a Monoalcohol

10.0 kg of ethanol and 0.50 kg of solid potassium hydroxide were used as initial charge in a 60 l pressure autoclave with stirrer, reactor heating system and reactor cooling system metering equipment for solid and liquid substances and alkylene oxides, and equipment for nitrogen inertization, and a vacuum system the mixture was inertized with nitrogen, with stirring, a nitrogen inlet pressure of 2 bar was set, and the mixture was heated to 100° C. An alkylene oxide mixture composed of 7.70 kg of propylene oxide and 23.0 kg of ethylene oxide was then added. During the course of the addition, the temperature was increased from 100 to 115° C. Reaction was then continued at 115° C. for 3 h.

The following values were determined on the resultant product:

| | | |
|---|---|---|
| Hydroxy number: | 287 | mg KOH/g |
| Alkali metal content: | 1.11% | of KOH |

10.0 kg of the alkaline product described above were used as initial charge in the pressure autoclave described above and heated, with stirring, to 110° C., using a nitrogen inlet pressure of 2 bar. A mixture of alkylene oxides, composed of 13.9 kg of propylene oxide and 41.6 kg of ethylene oxide, was added. During the addition, the reaction temperature was increased to 115° C. Reaction was continued at 115° C. for 2 h. The resultant alkaline product was hydrolyzed with water, neutralized with phosphoric acid, filtered, and vacuum-stripped.

| Hydroxy number: | 55.0 | mg KOH/g |
|---|---|---|
| Acid number: | 0.033 | mg KOH/g |
| pH: | 6.28 | |
| Water: | 0.016% | |
| Alkali metal content: | 2.1 | mg K/kg |

### Example 3

750 g (0.735 mol) of monohydric polyetherol from Example 2 were weighed into a 1 l four-necked flask with 44.15 g of acetic acid (0.735 mol, 100% of the stoichiometric amount required) and 75.05 g of acetic anhydride (0.735 mol), and slowly heated to 160° C., with nitrogen flushing. Once the temperature of 160° C. had been reached, the catalyst (50 ppm of stannous dioctoate) was added to the solution. After 7 h, the excess acetic acid was removed by distillation in vacuo. Analysis then gave an acid number of <0.1 mg KOH/g and an OH value of 0.7 mg KOH/g.

### Example 4

### Synthesis of a Plasticizer Based on PO/EO Polyol

450 g (0.24 mol) of a dihydric polyol having a molar mass of 1840 g/mol and an EO/PO ratio of 1:3 (BASF Aktiengesellschaft) were weighed into a 11 four-necked flask with 28.8 g of acetic acid (0.48 mol, 100% of the stoichiometric amount required) and 49.0 g of acetic anhydride (0.48 mol), and slowly heated to 160° C., with nitrogen flushing. Once the temperature of 160° C. had been reached, the catalyst (50 ppm of stannous dioctoate) was added to the solution. After 7 h, the excess acetic acid was removed by distillation in vacuo. Analysis then gave an acid number of <0.1 mg KOH/g and an OH value of 0.7 mg KOH/g.

### Example 5

### Example 5.1

Pluriol® A 131 R, a product of BASF Aktiengesellschaft, which can be used as inventive plasticizer. Pluriol® A 131 R is an allyl-started methoxy-terminated EC-PO ether whose EC/PO ratio is 2:1.

### Example 5.2

Pluriol® A 111 R, a product of BASF Aktiengesellschaft, which can be used as inventive plasticizer. Pluriol® A 111 R is an allyl-started methoxy-terminated EO-PO ether whose EC/PO ratio is 1:1.

The water content of the commercially available products is >0.2% by weight, and they are therefore dried prior to use. The usual method here heats the product under nitrogen to 140° C. in a rotary evaporator and continues rotation under a gentle current of nitrogen until water content is <0.02% by weight.

### Example 6

Ether TPU Elastollan® 1185 A (Elastogran GmbH) and ester TPUs of the following grades: Elastollan® 685 A, B85 A, and S85 A were processed in a laboratory extruder with slot die to give films of thickness 200 μm.

Circular pieces of diameter 1.5 cm were cut out from the TPU films, weighed, immersed in one of the plasticizers described in Table 1, and stored at room temperature for 5 weeks. The test specimen was then removed, cleaned to remove adhering plasticizer, and again weighed. The difference between the first and the final weighing is a measure of the amount of plasticizer absorbed and describes the compatibility of the plasticizer with the TPU.

TABLE 1
Solubility experiments

| Plasticizer | EO | PO | | |
|---|---|---|---|---|
| (Example | content | content | Solubility in | Solubility in |
| number) | in % | in % | Elastollan 1185 A | Elastollan S 85 A |
| 5.1 | 66 | 33 | 47% | 38% |
| 5.2 | 50 | 50 | 14% | 19% |
| 4 | 25 | 75 | 4.9% | 0.7% |
| 1 | 75 | 25 | 24% | 39% |
| 3 | 75 | 25 | Film dissolved | Film dissolved |

As can be seen from Table 1, the solubility is directly dependent on the EO content of the plasticizer. EO content<50% leads to very poor solubility, and EO content of 75% leads to ver good solubility. The solubility of plasticizer from Example 3 is particularly good. Here, the EO and PO units have been incorporated randomly.

### Example 7

### Production of an Ester TPU

1000 g of a polyesterol (Lupraphen® 8110, BASF Aktiengesellschaft) were heated to 80° C. in a 2 l tinplate bucket. 254 g of the inventive plasticizer 5.1 were then added, with stirring. 79 g of 1,4-butanediol and 8 g of Elastostab® H 01 (Elastogran GmbH) were then added. The solution was then heated to 75° C., and then 349 g of 4,4′-MDI (methylenediphenyl diisocyanate) were added and stirred until the solution was homogeneous. The reaction mixture was then poured into a flat dish and heat-conditioned at 125° C. for 10 min on a hot plate. The resultant skin was then heat-conditioned at 100° C. for 24 h in a heated cabinet. The cast sheets were granulated and then processed in an injection molding machine to give 2 mm injection-molded sheets. The Shore hardness of the product was 73 A.

Production of an Ether TPU

600 g of a polyetherol (PTHF 1000, BASF Aktiengesellschaft) were heated to 80° C. in a 2 l tinplate bucket. 250 g of the inventive plasticizer 5.1 were then added, with stirring. 72 g of 1,4-butanediol were then added. The solution was then heated to 75° C. and then 360 g of 4,4′-MDI (methylenediphenyl diisocyanate) were added and stirred until the solution was homogeneous. The reaction mixture was then poured into a flat dish and heat-conditioned at 125° C. for 10 min on a hot plate. The resultant skin was then heat-conditioned at 100° C. for 24 h in a heated cabinet. The cast sheets were granulated and then processed in an injection molding machine to give 2 mm injection-molded sheets. The Shore hardness of the product was 66 A.

### Example 8

300 g of Pluriol® A 350E (BASF Aktiengesellschaft) (methyl polyethylene glycol) were weighed into a 500 ml four-necked flask with 111.41 g of 4,4-MDI and heated to 90° C., with stirring. After four hours, the experiment was terminated and the product was analyzed. The NCO content was 0.200% of free NCO.

### Example 9

Using a method based on Example 7b, two ether TPUs were produced. The proportion of plasticizer was 20%. For specimens 9 a, plasticizer 5.1 was used, and for specimen 9 b plasticizer 8 was used. The products were granulated after production of the skin.

The two products were processed in a laboratory extruder with hose die to give a hose. The product comprising plasticizer from Example 8 is very difficult to process. Inter alia, the pressure in the extruder is very low, indicating a high degree of retrocleavage. This is also shown by analysis of the isocyanate content of the granulated material after processing. The value for specimen 9b), at 0.053% of residual NCO, is almost twice as high as for specimen 9a) (0.032% of residual NCO). Product 9b) shows severe bloom 2 days after processing, and this indicates the formation of oligomeric urethanes from the retrocleavage products.

1: A thermoplastic comprising plasticizer (i), wherein the plasticizer (i) is based on a polyether having at least one hydroxy group and the at least one hydroxy group in the plasticizer has been alkylated or has been esterified with a monocarboxylic acid.

2: The thermoplastic according to claim 1, wherein the molar mass of the compound (i) is from 400 to 6000 g/mol.

3: The thermoplastic according to claim 1, wherein the compound (i) is liquid at 25° C. at a pressure of 1 bar.

4: The thermoplastic according to claim 1, wherein the proportion by weigh of ethylene oxide units in the polyetherol is from 50 to 95% by weight.

5: The thermoplastic according to claim 1, wherein the plasticizer (i) is based on ethylene oxide and on propylene oxide, and the proportion by weight of ethylene oxide units in the plasticizer (i) is from 66 to 80% by weight, the % by weight data being based on the proportion by weight of the structural unit —[O—CH₂—CH₂]—, based on the total weight of the compound (i).

6: The thermoplastic according to claim 1, wherein the number-average molar mass of the plasticizer (i) is smaller than the weight-average molar mass of the plasticizer (i).

7: The thermoplastic according to claim 1, wherein the hydroxy number of the plasticizer (i) is smaller than 10 mg KOH/g.

8: The thermoplastic according to claim 1, wherein the acid number of the plasticizer (i) is smaller than 2.

9: The thermoplastic according to claim 1, wherein the Hazen number indicating the intrinsic color of the plasticizer (i) is smaller than 100.

10: The thermoplastic according to claim 1, wherein the alkali metal content of the plasticizer (i) is smaller than 40 ppm.

11: The thermoplastic according to claim 1, wherein the water content of the plasticizer (i) is smaller than 0.2% by weight.

12: The thermoplastic according to claim 1, wherein the amount of the plasticizers (i) present in the thermoplastic is from 1 to 60% by weight, based on the total weight of the thermoplastic comprising the plasticizer (i).

13: The thermoplastic according to claim 1, whose Shore hardness is from 40 A to 80 A.

14: A process for the production of thermoplastic polyurethanes, which comprises adding to the thermoplastic polyurethane, during and/or after the production process, plasticizer according to claim 1.

15: A process for the esterification of a polyether having at least one hydroxy group with a carboxylic acid, which comprises heating the polyether in a reactor to 110-160° C. with a stoichiometric amount of acetic anhydride and an amount of acetic acid which is from 10 to 100% by weight of the stoichiometric amount of acetic acid.
